(19) United States
(12) Patent Application Publication
(10) Pub. No.: US 2005/0013007 A1
(43) Pub. Date: Jan. 20, 2005

(54) Polarization interleaver and optical communication system

(76) Inventors: Tomomi Sano, Yokohama-shi (JP); Hiroshi Suganuma, Yokohama-shi (JP); Tamoya Kenmochi, Hashimoto-shi (JP)

Correspondence Address: MCDERMOTT WILL & EMERY LLP, 600 13TH STREET, N.W., WASHINGTON, DC, 20005-3096, US

(21) Appl. No.: 10/499,038

(22) PCT Filed: Dec. 10, 2002
(86) PCT No.: PCT/JP02/12885

(30) Foreign Application Priority Data
Dec. 17, 2001 (JP) 2001-383150

(51) Int. Cl. G02B 27/14

(52) U.S. Cl. 359/634

(57) ABSTRACT

In a polarized wave interleaver 100, signal light of a first wavelength band Λ₁ of polarized light component in a first orientation, which enters an input port 111, proceeds to a first path P₁ through a first polarized wave separation element 131. Even after passing through a wavelength filter 140, the polarized light component in the first orientation is maintained as it is. And the light proceeds to a third path P₃ through a second polarized wave separation element 132, and is output from a first output port 121. Signal light of a second wavelength band Λ₂ of polarized light component in a second orientation, which enters the input port 111, proceeds to a second path P₂ through the first polarized wave separation element 131, and is converted to the polarized light component in the first orientation by the wavelength filter 140. And the light proceeds to a fourth path P₄ through the second polarized wave separation element 132, and is output from a second output port 122. The wavelength filter 140 includes a first multi-refraction material 141, a second multi-refraction material 142 and a third multi-refraction material 143. The optical thickness of the three multi-refraction materials 141-143 has a predetermined ratio; and the orientation of the C axis falls within a predetermined range.

### TECHNICAL FIELD

The present invention relates to a polarized wave interleaver for branching signal light of multiple wavelengths into first wavelength band and second wavelength band or integrating thereof, and an optical communication system including the polarized wave interleaver.

### BACKGROUND ART

A wavelength division multiplexing (WDM) optical communication system, which multiplexes signal light of multiple wavelengths and transmits the same to an optical fiber transmission path, is capable of receiving and transmitting a large scale information at a high speed. The above-described WDM optical communication system is required to transmit further large scale information, and it is under review that signal light, which has many wavelengths, is multiplexed and transmitted in an optical manner. In the WDM optical communication system, which is now in practical use, in order to multiplex signal light of more wavelengths, it is now examined to use new wavelengths among the wavelengths under practical use. In such case, an interleaver for branching the signal light of wavelengths, which are newly used, from the signal light of wavelengths, which are already used, is required.

That is, the interleaver inputs signal light of multi-wavelength (λ₁, λ₂, λ₃, λ₄, λ₅, λ₆, . . . ) from the input port, branches the same into signal light of wavelengths (λ₁, λ₃, λ₅, . . . , λ₂ₙ₋₁, . . . ) of a first wavelength band Λ₁ and signal light of wavelengths (λ₂, λ₄, λ₆, . . . , λ₂ₙ, . . . ) of a second wavelength band Λ₂; and outputs the signal light of the first wavelength band Λ₁ to a first output port, and outputs the signal light of the second wavelength band Λ₂ to a second output port; where λ₁<λ₂<λ₃<λ₄<λ₅<λ₆< . . . . The interleaver is capable of inputting signal light of the first wavelength band Λ₁ and signal light of the second wavelength band Λ₂, and multiplexing to output the same.

The following WDM optical communication system is also under review; that is, the signal light of the first wavelength band Λ₁ is transmitted as a polarized light component in a first orientation; and the signal light of the second wavelength band Λ₂ is transmitted as a polarized light component in the second orientation to permit the system to be larger in capacity. Here, the first orientation and the second orientation are made cross at right angle to each other. In this case, the interleaver inputs input signal, which includes signal light of the first wavelength band Λ₁ of a polarized light component in the first orientation and signal light of a second wavelength band Λ₂ of the polarized light component in a second orientation, through the input port and branches the same to output signal light of the first wavelength band to a first output port and output signal light of the second wavelength band to a second output port. The interleaver as described above is called as polarized wave interleaver.

As a polarized wave interleaver, which has a simplest constitution, a polarized wave interleaver employing a polarized wave separation element (for example, polarized wave beam splitter) is available. When the signal light of the input first wavelength band Λ₁ includes only the polarized light component in the first orientation, and the signal light of the input second wavelength band Λ₂ includes only the polarized light component in the second orientation, and when the isolation between the beams of the input signal light is high, even when the polarized wave interleaver is constituted as described above, the branching or integrating with satisfactory characteristics can be achieved.

However, in the actual case, at the initial point when the signal light is transmitted from an optical transmitter, even when each signal light includes only the polarized light component in a particular single orientation, while being transmitted through an optical fiber transmission path, a part of the signal light is converted into a polarized light component in the other orientation. At the point when the signal light reaches a polarized wave interleaver provided in an optical receiver (or optical relay), not only the polarized light component in the initial particular orientation, but also the polarized light component in the orientation perpendicular thereto are included. In such case, with the polarized wave interleaver constituted as described above, the branching characteristics are poor.

The present invention has been achieved to solve the above-described problems. An object of the present invention is to provide a polarized wave interleaver with satisfactory branching characteristics, and an optical communication system including such polarized wave interleaver.

### DISCLOSURE OF THE INVENTION

A polarized wave interleaver according to the present invention is an polarized wave interleaver, which inputs input signal including signal light of a first wavelength band of a polarized light component in a first orientation and signal light of a second wavelength band of a polarized light component in a second orientation from an input port and branches the same, outputs the signal light of the first wavelength band to a first output port, and outputs the signal light of the second wavelength band to a second output port, comprises (1) a first polarized wave separation element that separates each signal light of input signal input to the input port into the respective polarized light components in the first orientation and the second orientation perpendicular to each other, outputs the polarized light component in the first orientation of each signal light to a first path, and outputs the polarized light component in the second orientation of each signal light to a second path, (2) a wavelength filter that inputs each signal light output from the first polarized wave separation element to the first path and the second path, outputs the signal light of the first wavelength band of each path as the polarized light component at the point of input, outputs the signal light of the second wavelength band of each path as the polarized light component perpendicular to the polarized light component at the point of input, (3) a second polarized wave separation element that inputs each signal light output from the wavelength filter to each of the first path and the second path, separates each signal light of each path into the respective polarized light components in the first orientation and the second orientation, outputs the signal light of the first wavelength band reached from the first path to the first output port, and outputs the signal light of the second wavelength band reached from the second path to the second output port, wherein the wavelength filter includes, (1) in a predetermined direction from the input port side to the first output port and the second output port side in order, a first multi-refraction material, a second multi-refraction material and a third multi-refraction material; (2) given that the optical thickness along the predetermined direction of the first multi-refraction material is L₁, the optical thickness along the predetermined direction of the second multi-refraction material is L₂, and the optical thickness along the predetermined direction of the third multi-refraction material is L₃, the ratio L₁:L₂:L₃ is 1:2:2; (3) each orientation of the C axis of the first multi-refraction material, the second multi-refraction material, and the third multi-refraction material is parallel with a predetermined plane perpendicular to the predetermined direction; (4) the angle formed by the orientation of the C axis of the first multi-refraction material with the first orientation falls within a range of 45°±3°; (5) the angle formed by the orientation of the C axis of the second multi-refraction material with the first orientation falls within a range of −69.6°±3°; and (6) the angle formed by the orientation of the C axis of the third multi-refraction material with the first orientation falls within a range of 82.5°±3°.

According to this polarized wave interleaver, when signal light of the first wavelength band of the polarized light component in the first orientation enters from the input port, the input signal light of the first wavelength band proceeds to the first path through the first polarized wave separation element. Even after passing through the wavelength filter, the polarized light component in the first orientation is maintained as it is. And the light is output from the first output port through the second polarized wave separation element. Also, when signal light of the second wavelength band of polarized light component in the second orientation enters the input port, the input signal light of the second wavelength band proceeds to the second path through the first polarized wave separation element. The signal light is converted to the polarized light component in the first orientation by the wavelength filter. And the light is output from a second output port through the second polarized wave separation element. However, even when the signal light of the second wavelength band of the polarized light component in the first orientation or the signal light of the first wavelength band of the polarized light component in the second orientation enters the input port, the signal light is not output from either the first output port or the second output port. Thus, the signal light of multi-wavelength can be branched, or contrarily, integrated. In the polarized wave interleaver, the ratio of each optical thickness of the three multi-refraction materials constituting the wavelength filter is 1:2:2; and each orientation of the C axis of the three multi-refraction materials falls within the above-mentioned range. Thereby, satisfactory isolation between the signal light wavelengths can be obtained, and also, the transmittance adjacent to the signal light wavelength can be flattened (flat top).

An optical communication system according to the present invention is an optical communication system, which multiplexes signal light of a first wavelength band of a polarized light component in a first orientation and signal light of a second wavelength band of a polarized light component in a second orientation and transmits the same, includes a polarized wave interleaver according to the above-mentioned present invention, wherein the signal light of multi-wavelength is multiplexed or branched by the polarized wave interleaver.

According to this optical communication system, through the optical transmission path from the integrating polarized wave interleaver at the transmitting end to the branching polarized wave interleaver at the receiving end, the signal light of the first wavelength band can be transmitted as the polarized light component in the first orientation; and the signal light of the second wavelength band can be transmitted as the polarized light component in the second orientation. Accordingly, large-scale information can be transmitted. Further, in the optical communication system, owing to the integrating polarized wave interleaver at the transmitting end, at the point of transmission to the optical fiber transmission path, the signal light of the first wavelength band includes only the polarized light component in the first orientation; and the signal light of the second wavelength band includes only the polarized light component in the second orientation. However, while being transmitted through the optical fiber transmission path, a part of signal light is converted into a polarized light component in the other orientation; and at the point of arrival at the polarized wave interleaver at the receiving end, each signal light includes not only the polarized light component in a specific orientation but also the polarized light component in the orientation perpendicular thereto.

In such case, since the polarized wave interleaver, which has the same configuration as the polarized wave interleaver according to the above-described present invention, is employed, the optical communication system is superior in branching characteristics at the polarized wave interleaver, and accordingly, superior in transmission quality.

### BRIEF DESCRIPTION OF THE DRAWINGS

FIG. 1 is a view showing the configuration of a polarized wave interleaver 100 according to an embodiment.

FIG. 2 is a view showing the transmission characteristics of the polarized wave interleaver 100 according to the embodiment.

FIG. 3 is a view showing the transmission characteristics of the polarized wave interleaver 100 according to the embodiment; and the dependence of the first multi-refraction material 141 on the orientation of the C axis is shown.

FIG. 4 is a view showing the transmission characteristics of the polarized wave interleaver 100 according to the embodiment; and the dependence of the second multi-refraction material 142 on the orientation of the C axis is shown.

FIG. 5 is a view showing the transmission characteristics of the polarized wave interleaver 100 according to the embodiment; and the dependence of the third multi-refraction material 143 on the orientation of the C axis is shown.

FIG. 6 is a view showing the configuration of an optical communication system 1 according to the embodiment.

### BEST MODE FOR CARRYING OUT THE INVENTION

Now, an embodiment of the present invention will be described in detail with reference to the accompanying drawings. In the descriptions of the drawings, the same elements will be given with the same reference numerals and the redundant descriptions thereof will be omitted.

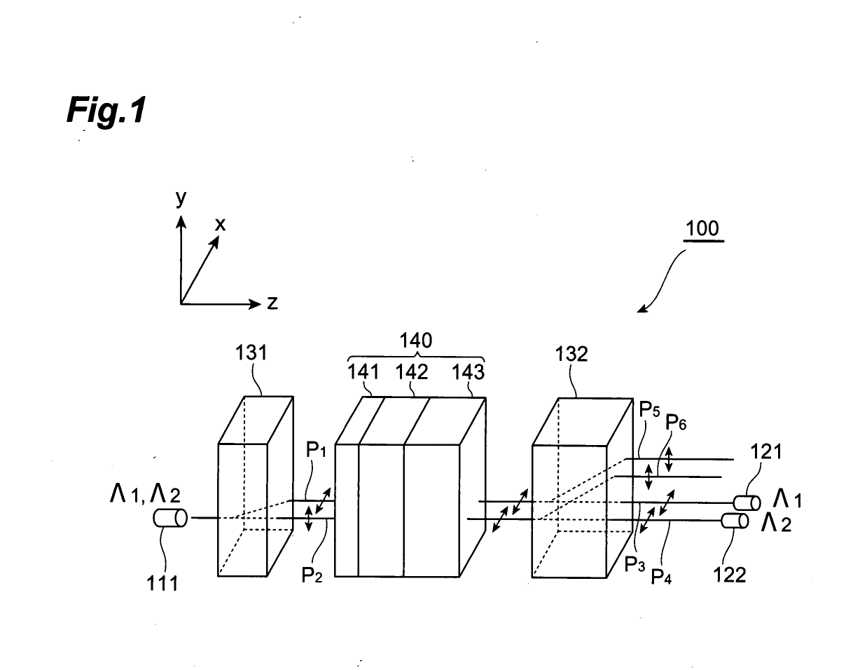

FIG. 1 is a view showing the configuration of a polarized wave interleaver 100 according to the present embodiment. In the drawing, there is shown xyz rectangular coordinates, in which the direction of the z-axis is prescribed to represent the traveling direction of light. The polarized wave interleaver 100 comprises, from an input port 111 toward output ports 121, 121 in order, a first polarized wave separation element 131, a wavelength filter 140 and a second polarized wave separation element 132.

The first polarized wave separation element 131 separates a beam of signal light, which enters the input port 111, into polarized light components in a first orientation (the direction of the x-axis in the figure) and a second orientation (the direction of the y-axis in the drawing) respectively with respect to the input signal light, which are perpendicular to each other. The polarized light component in the first orientation of each signal light is output to a first path P₁; and the polarized light component in the second orientation of each signal light is output to a second path P₂. As the first polarized wave separation element 131, for example, a multi-refraction material, which has the C axis on the x-z plane, is used.

The wavelength filter 140 inputs each signal light, which is output from the first polarized wave separation element 131 to each of the first path P₁, and the second path P₂ The signal light of the first wavelength band Λ₁ of each path is output as the polarized light component at the point of input; the signal light of the second wavelength band Λ₂ of each path is output as the polarized light component, which is perpendicular to the polarized light component at the point of input. The wavelength filter 140 comprises, from the input port 111 side to the output ports 121 and 122 side in order, a first multi-refraction material 141, a second multi-refraction material 142 and a third multi-refraction material 143. The first wavelength band Λ₁ includes signal light wavelengths (λ₁, λ₃, λ₅ . . . , λ₂ₙ₋₁ . . . ); and the second wavelength band Λ₂ includes signal light wavelengths (λ₂, λ₄, λ₆, . . . , λ₂ₙ, . . . ), where λ₁<λ₂<λ₃<λ₄<λ₅<λ₆< . . . .

Given that the optical thickness along the direction of the z-axis of the first multi-refraction material 141 is L₁; the optical thickness along the direction of the z-axis of the second multi-refraction material 142 is L₂; and the optical thickness along the direction of the z-axis of the third multi-refraction material 143 is L₃, the ratio of L₁:L₂:L₃ is 1:2:2. Each optical thickness L₁˜L₃ is appropriately established depending on the refraction index with respect to the normal light beam and the abnormal light beam of the respective multi-refraction materials 141˜143 as well as the interval of the frequency of the input signal light with multiple wavelengths. The orientation of the C axis of the three multi-refraction materials 141˜143 is parallel to the x-y plane respectively, which is perpendicular to the direction of the Z-axis. The angle, which is formed by the orientation of the C axis of the first multi-refraction material 141 with the direction of x-axis, falls within a range of 45°±3°. The angle, which is formed by the orientation of the C axis of the second multi-refraction material 142 with the direction of x-axis, falls within a range of −69.6°±3°. Also, the angle, which is formed by the orientation of the C axis of the third multi-refraction material 143 with the direction of x-axis, falls within a range of 82.5°±3°.

The second polarized wave separation element 132 inputs each signal light, which is output from the wavelength filter 140 to the first path P₁ and the second path P₂, and separates each signal light of the respective paths into the polarized light components in the first orientation and the second orientation respectively. The second polarized wave separation element 132 outputs the signal light of the first wavelength band Λ₁, which reaches via the first path P₁, to the third path P₃; and outputs the signal light of the second wavelength band Λ₂, which reaches via the second path P₂, to the fourth path P₄. As the second polarized wave separation element 132, for example, a multi-refraction material, which has the C axis on the y-z plane, is used.

The signal light of the first wavelength band Λ₁, which is output from the second polarized wave separation element 132 to the third path P₃, is output from the first output port 121. Also, the signal light of the second wavelength band Λ₂, which is output from the second polarized wave separation element 132 to the fourth path P₄, output from the second output port 122.

Next, the operation of the polarized wave interleaver 100 according to the embodiment will be described. Hereinafter, the operation in the following cases will be described separately; i.e., the case where a signal light of the first wavelength band Λ₁ of the polarized light component in the first orientation enters the input port 111; the case where a signal light of the second wavelength band Λ₂ of the polarized light component in the second orientation enters the input port 111; the case where a signal light of the second wavelength band Λ₂ of the polarized light component in the first orientation enters the input port 111; and the case where a signal light of the first wavelength band Λ₁ of the polarized light component in the second orientation enters the input port 111.

In the case where a signal light of the first wavelength band Λ₁ of the polarized light component in the first orientation enters the input port 111, the light proceeds as described below. The signal light of the first wavelength band Λ₁ of the polarized light component in the first orientation, which enters the input port 111, proceeds to the first path P₁ through the first polarized wave separation element 131. Even after passing through the wavelength filter 140, the polarized light component in the first orientation is maintained as it is. And the light proceeds to the third path P₃ through the second polarized wave separation element 132, and is output from the first output port 121.

In the case where a signal light of the second wavelength band Λ₂ of the polarized light component in the second orientation enters the input port 111, the light proceeds as described below. The signal light of the second wavelength band Λ₂ of the polarized light component in the second orientation, which enters the input port 111, proceeds to the second path P₂ through the first polarized wave separation element 131, and is converted to the polarized light component in the first orientation by the wavelength filter 140. And the light proceeds to the fourth path P₄ through the second polarized wave separation element 132, and is output from the second output port 122.

In the case where a signal light of the second wavelength band Λ₂ of the polarized light component in the first orientation enters the input port 111, the light proceeds as described below. The signal light of the second wavelength band Λ₂ of the polarized light component in the first orientation, which enters the input port 111, proceeds to the first path P₁ through the first polarized wave separation element 131, and is converted to the polarized light component in the second orientation by the wavelength filter 140. And the light proceeds to the fifth path P₅ through the second polarized wave separation element 132, but is not output from the first output port 121 or the second output port 121.

In the case where a signal light of the first wavelength band Λ₁ of the polarized light component in the second orientation enters the input port 111, the light proceeds as described below. The signal light of the first wavelength band Λ₁ of the polarized light component in the second orientation, which enters the input port 111, proceeds to the second path P₂ through the first polarized wave separation element 131. Even after passing through the wavelength filter 140, the polarized light component in the second orientation is maintained as it is. And the light proceeds to the sixth path P₆ through the second polarized wave separation element 132, but is not output from the first output port 121 or the second output port 121.

As described above, in the polarized wave interleaver 100, when a signal light of the first wavelength band Λ₁ of the polarized light component in the first orientation enters the input port 111, the light is output from the first output port 121. Also, when the signal light of the second wavelength band Λ₂ of the polarized light component in the second orientation enters the input port 111, the light is output from the second output port 122. However, as for the signal light of the second wavelength band Λ₂ of the polarized light component in the first orientation, or the signal light of the first wavelength band 79 ₁ of the polarized light component in the second orientation, even when the light enters the input port 111, the light is not output from either the first output port 121 or the second output port 121.

That is, when a signal light of the first wavelength band Λ₁ of the polarized light component in the first orientation and the signal light of the second wavelength band Λ₂ of the polarized light component in the second orientation enter the input port 111, the polarized wave interleaver 100 branches the signal light, and outputs the signal light of the first wavelength band Λ₁ to the first output port 121; and outputs the signal light of the second wavelength band Λ₂ to the second output port 122. Further, to the contrary, when a signal light of the first wavelength band Λ₁ is input through the first output port 121 and a signal light of the second wavelength band Λ₂ is input from the second output port 122, the polarized wave interleaver 100 integrates these beams of signal light and outputs the integrated signal light to the input port 111.

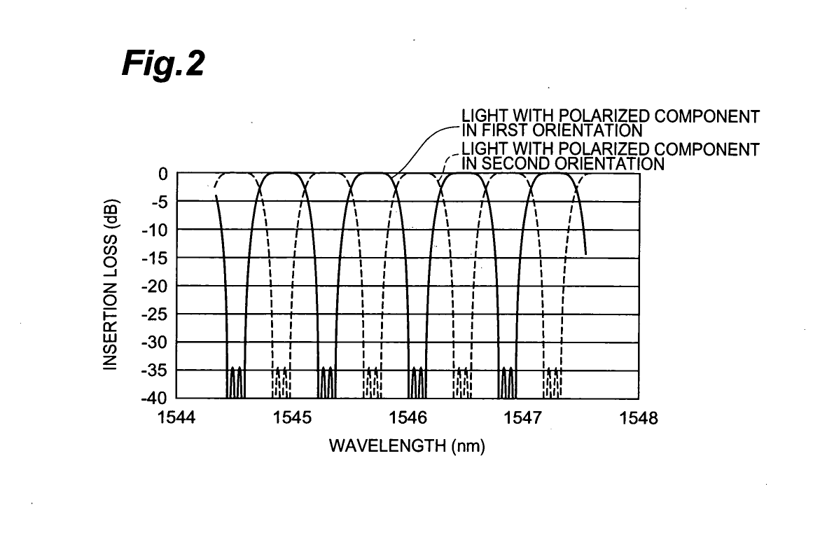

FIG. 2 is a view showing the transmission characteristics of the polarized wave interleaver 100 according to the present embodiment. Here, each of the three multi-refraction materials 141-143 constituting the wavelength filter 140 is formed from TiO₂. The optical thickness L₁ of the first multi-refraction material 141 is 5.82 mm. The optical thickness L₂ of the second multi-refraction material 142 is 11.64 mm. And the optical thickness L₃ of the third multi-refraction material 143 is 11.64 mm. The angle, which is formed by the orientation of the C axis of the first multi-refraction material 141 with the direction of x-axis, is 45°. The angle, which is formed by the orientation of the C axis of the second multi-refraction material 142 with the direction of x-axis, is −69.6°. And the angle, which is formed by the orientation of the C axis of the third multi-refraction material 143 with the X-axis, is 82.5°. In this case, the polarized wave interleaver 100 integrates or branches the signal light of multi-wavelength with a frequency interval of 50 GHz.

In FIG. 2, the wavelength dependence of the loss when the light of polarized light component in the first orientation, which is input to the input port 111, is output from the first output port 121; and the wavelength dependence of the loss when the light of polarized light component in the second orientation, which is input to the input port 111, is output from the second output port 122 are shown respectively. The ratio of the optical thickness among the multi-refraction materials 141 to 143 is arranged so as to be 1:2:2; and the orientation of the C axis of the respective multi-refraction materials 141 to 143 is arranged as described above. Thereby, as demonstrated in FIG. 2, in the polarized wave interleaver 100, the isolation between the signal light wavelengths is satisfactorily increased, and the transmittance adjacent to the signal light wavelength is flattened (flat-top).

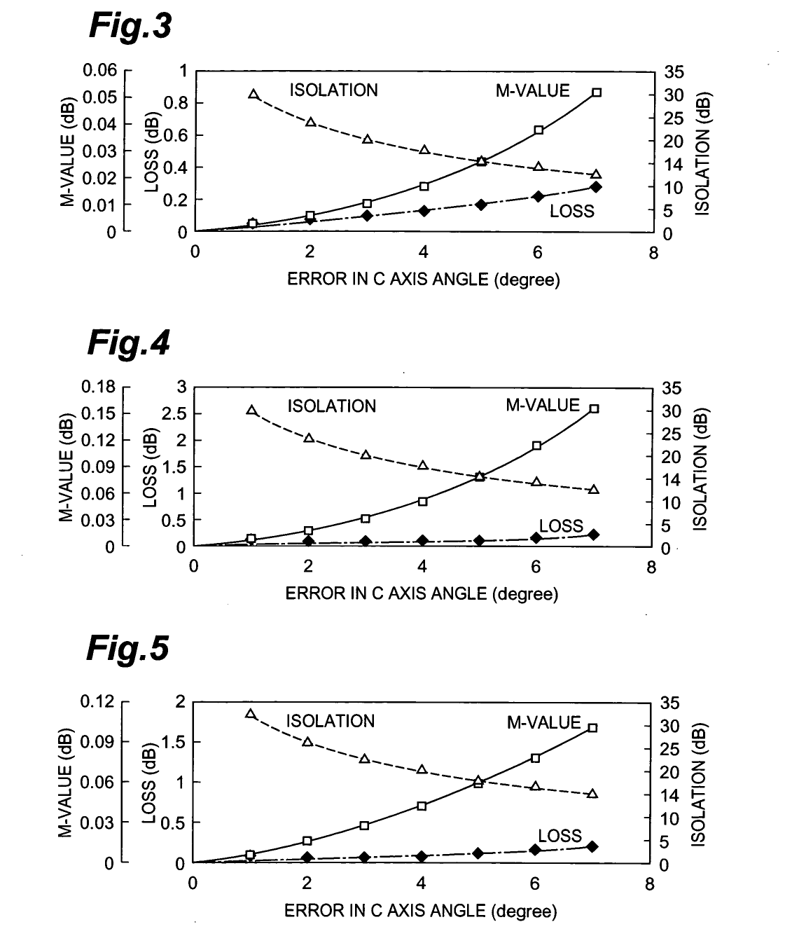

FIG. 3 is a view showing the transmission characteristics of the polarized wave interleaver 100 according to the present embodiment; and the dependence of the first multi-refraction material 141 on the orientation of the C axis is shown. In this drawing, the point where the angle, which is formed by the orientation of the C axis of the first multi-refraction material 141 with the direction of the x-axis, is 45° is taken to as the reference; and the difference of angle from the reference is plotted on the abscissa axis. Also, in this view, the dependence of the isolation, the loss and the m-value on the difference of angle is shown respectively.

FIG. 4 is a view showing the transmission characteristics of the polarized wave interleaver 100 according to the present embodiment; and the dependence of the second multi-refraction material 142 on the orientation of the C axis is shown. In this drawing, the point where the angle, which is formed by the orientation of the C axis of the second multi-refraction material 142 with the direction of the x-axis, is −69.6° is taken to as the reference, and the difference of angle from the reference is plotted on the abscissa axis. Also, in this drawing, the dependence of the isolation, the loss and the m-value on the difference of angle is shown respectively.

FIG. 5 is a view showing the transmission characteristics of the polarized wave interleaver 100 according to the embodiment; and the dependence of the third multi-refraction material 143 on the orientation of the C axis is shown. In this drawing, the point where the angle, which is formed by the orientation of the C axis of the third multi-refraction material 143 with the direction of the x-axis, is 82.50° is taken to as the reference, and the difference of angle from the reference is plotted on the abscissa axis. Also, in this drawing, the dependence of the isolation, the loss and the m-value on the difference of angle is shown respectively.

In FIG. 3 to FIG. 5, each of the multi-refraction materials 141 to 143 is formed from TiO₂. The optical thickness L₁ of the first multi-refraction material 141 is 5.82 mm. The optical thickness L₂ of the second multi-refraction material 142 is 11.64 mm. The optical thickness L₃ of the third multi-refraction material 143 is 11.64 mm.

As demonstrated in FIG. 3 to FIG. 5 respectively, in any of the multi-refraction materials 141 to 143, when the difference of angle is 3° or less, the isolation between the signal light wavelengths is 20 dB or more; the m-value is 0.03 dB or less; and the loss of the signal light is 0.1 dB or less. Thus, the polarized wave interleaver 100 is superior in branching characteristics.

Here, the wording “m-value” means ((maximum value of transmittance)−(minimum value of transmittance)) in a range of ±0.06 nm from the wavelength of the signal light.

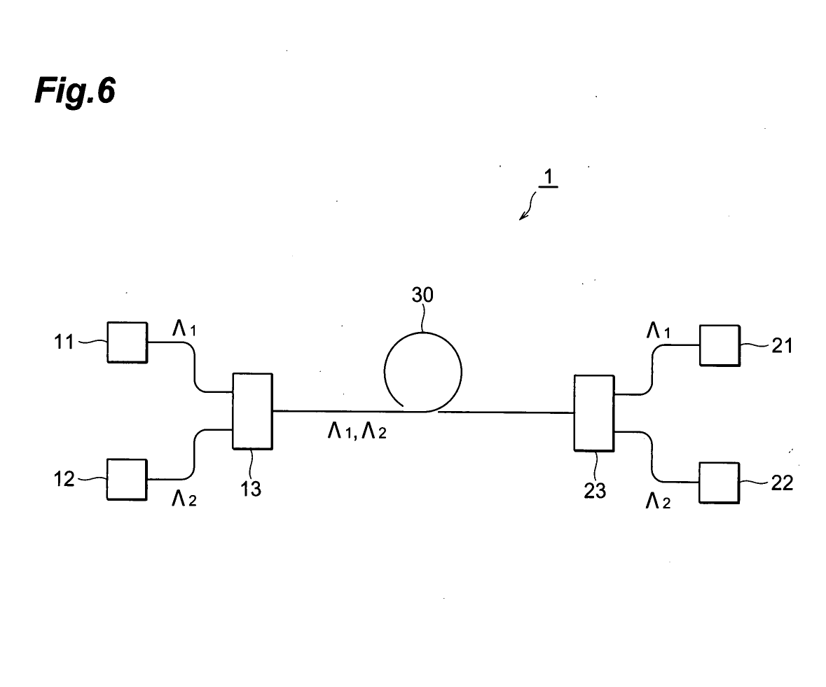

Next, an optical communication system 1 according to the embodiment will be described. FIG. 6 is a view showing the configuration of the optical communication system 1 according to the present embodiment. The optical communication system 1 comprises optical transmitters 11 and 12, an integrating polarized wave interleaver 13, optical receivers 21 and 22, and a branching polarized wave interleaver 23. Laid between the polarized wave interleaver 13 and the polarized wave interleaver 23 is an optical fiber transmission path 30. Each of the polarized wave interleavers 13 and 23 has the same configuration as that of the polarized wave interleaver 100 according to the above-described embodiment.

The optical transmitter 11 multiplexes signal light of first wavelength band Λ₁ (λ₁, λ₃, λ₅, . . . , λ₂ₙ₋₁ , . . . ) and outputs the same. The optical transmitter 12 multiplexes signal light of second wavelength band Λ₂ (λ₂, λ₄, λ₆, . . . , λ₂ₙ, . . . ) and outputs the same. The polarized wave interleaver 13 inputs signal light of the first wavelength band Λ₁, which is output from the optical transmitter 11; also inputs signal light of the second wavelength band Λ₂, which is output from the optical transmitter 12, and multiplexes the above to transmit to the optical fiber transmission path 30. Here, the signal light of the first wavelength band Λ₁, which is transmitted from the polarized wave interleaver 13 to the optical fiber transmission path 30 is a polarized light component in a first orientation; and the signal light of the second wavelength band Λ₂, which is transmitted from the polarized wave interleaver 13 to the optical fiber transmission path 30, is a polarized light component in a second orientation.

The polarized wave interleaver 23 inputs the signal light of multi-wavelength, which has propagated through the optical fiber transmission path 30 and reached there, and branches into a first wavelength band Λ₁ and a second wavelength band Λ₂ to output therefrom. The optical receiver 21 inputs the signal light of the first wavelength band Λ₁ of the polarized light component in the first orientation, which has been output from the polarized wave interleaver 23, further branches the above into each wavelength and receives the signal light of each wavelength. Also, the optical receiver 22 inputs the signal light of the second wavelength band Λ₂ of the polarized light component in the second orientation, which has been output from the polarized wave interleaver 23, further branches the above into each wavelength and receives the signal light of each wavelength.

In the optical communication system 1, on the optical fiber transmission path 30 from the polarized wave interleaver 13 at the transmitting end to the polarized wave interleaver 23 at the receiving end, the signal light of the first wavelength band Λ₁ is transmitted as the polarized light component in the first orientation, and the signal light of the second wavelength band Λ₂ is transmitted as the polarized light component in the second orientation. Thus, the optical communication system 1 is capable of transmitting large-scale information.

In the optical communication system 1 as described above, at the point of transmission from the polarized wave interleaver 13 at the transmitting end to the optical fiber transmission path 30, the signal light of the first wavelength band Λ₁ includes only the polarized light component in the first orientation; and the signal light of the second wavelength band Λ₂ includes only the polarized light component in the second orientation. However, while being transmitted through the optical fiber transmission path 30, a part of the signal light is converted into a polarized light component in the other orientation; and at the point of arrival at the polarized wave interleaver 23 at the receiving end, each signal light includes not only the polarized light component in a specific orientation but also the polarized light component in the orientation perpendicular thereto. In such case, since the polarized wave interleaver 23, which has the same configuration as the polarized wave interleaver 100 according to the above-described embodiment, is employed, the optical communication system 1 is superior in branching characteristics at the polarized wave interleaver 23, and accordingly, superior in transmission quality.

### INDUSTRIAL APPLICABILITY

As described above in detail, the polarized wave interleaver according to the present invention comprises the first polarized wave separation element, the wavelength filter and the second polarized wave separation element. The wavelength filter includes three multi-refraction materials. Each optical thickness of the three multi-refraction materials has a predetermined ratio. Each orientation of the C axis of the three multi-refraction materials falls within a predetermined range. Being confabulated as described above, the polarized wave interleaver is superior in branching characteristics.

1. A polarized wave interleaver, which inputs an input signal including a signal light of a first wavelength band of a polarized light component in a first orientation and a signal light of a second wavelength band of a polarized light component in a second orientation from an input port and branches the same, which outputs the signal light of said first wavelength band to a first output port, and which outputs the signal light of said second wavelength band to a second output port, comprising:
a first polarized wave separation element which separates each signal light of input signal input to said input port into the respective polarized light components in said first orientation and said second orientation perpendicular to each other, which outputs the polarized light component in said first orientation of each signal light to a first path, and which outputs the polarized light component in said second orientation of each signal light to a second path,
a wavelength filter which inputs each signal light output from said first polarized wave separation element to said first path and said second path, which outputs the signal light of said first wavelength band of each path as the polarized light component at the point of input, which outputs the signal light of said second wavelength band of each path as the polarized light component perpendicular to the polarized light component at the point of input,
a second polarized wave separation element which inputs each signal light output from said wavelength filter to each of said first path and said second path, which separates each signal light of each path into the respective polarized light components in said first orientation and said second orientation, which outputs the signal light of said first wavelength band reached from said first path to said first output port, and which outputs the signal light of said second wavelength band reached from said second path to said second output port, wherein
said wavelength filter includes, in a predetermined direction from said input port side to said first output port and said second output port side in order, a first multi-refraction material, a second multi-refraction material and a third multi-refraction material;
given that the optical thickness along said predetermined direction of said first multi-refraction material is L₁, the optical thickness along said predetermined direction of said second multi-refraction material is L₂, and the optical thickness along said predetermined direction of said third multi-refraction material is L₃, the ratio L₁:L₂:L₃ is 1:2:2;
each orientation of the C axis of said first multi-refraction material, said second multi-refraction material, and said third multi-refraction material be parallel with a predetermined plane perpendicular to said predetermined direction;
the angle formed by the orientation of the C axis of said first multi-refraction material with said first orientation falls within a range of 45°±3°;
the angle formed by the orientation of the C axis of said second multi-refraction material with said first orientation falls within a range of −69.6°±3°; and
the angle formed by the orientation of the C axis of said third multi-refraction material with said first orientation falls within a range of 82.5°±3°.

2. An optical communication system, which multiplexes signal light of a first wavelength band of a polarized light component in a first orientation and signal light of a second wavelength band of a polarized light component in a second orientation and transmits the same, including a polarized wave interleaver set forth in claim 1, wherein the signal light of multi-wavelength is multiplexed or branched by the polarized wave interleaver.
